(19) United States
(12) Patent Application Publication
(10) Pub. No.: US 2026/0143481 A1
(43) Pub. Date: May 21, 2026

(54) INTRA-CELL INTERFERENCE MITIGATION

(71) Applicant: QUALCOMM Incorporated, San Diego, CA (US)

(72) Inventors: Aviv REGEV, Tel Aviv (IL); Shay LANDIS, Hod Hasharon (IL); Ronen SHAKED, Kfar Saba (IL)

(21) Appl. No.: 18/954,170

(22) Filed: Nov. 20, 2024

(51) Int. Cl. H04W 72/044; H04W 72/541

(52) U.S. Cl. CPC H04W 72/046; H04W 72/541

(57) ABSTRACT

Various aspects of the present disclosure generally relate to wireless communication. In some aspects, a network node may identify, based on a schedule of upcoming transmissions in a cell served by the network node, an upcoming intra-cell interference scenario between a first user equipment (UE) and a second UE. The network node may transmit, to the first UE, an interference indication that indicates the first UE is to perform at least one of: null steering, altering a transmission beam of the first UE, or altering a reception beam of the first UE. Numerous other aspects are described.

### FIELD OF THE DISCLOSURE

Aspects of the present disclosure generally relate to wireless communication and specifically relate to techniques, apparatuses, and methods associated with intra-cell interference mitigation.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a network node. The method may include identifying, based on a schedule of upcoming transmissions in a cell served by the network node, an upcoming intra-cell interference scenario between a first user equipment (UE) and a second UE. The method may include transmitting, to the first UE, an interference indication that indicates the first UE is to perform at least one of: null steering, altering a transmission beam of the first UE, or altering a reception beam of the first UE.

Some aspects described herein relate to a method of wireless communication performed by a UE. The method may include transmitting, to a network node, at least one communication parameter, the at least one communication parameter including at least a direction of arrival (DOA) estimate. The method may include receiving, from the network node, an interference indication that indicates the UE is to perform at least one of: null steering, altering a transmission beam of the UE, or altering a reception beam of the UE.

Some aspects described herein relate to a network node for wireless communication. The network node may include one or more memories and one or more processors coupled to the one or more memories. The one or more processors may be individually or collectively configured to identify, based on a schedule of upcoming transmissions in a cell served by the network node, an upcoming intra-cell interference scenario between a first UE and a second UE. The one or more processors may be individually or collectively configured to transmit, to the first UE, an interference indication that indicates the first UE is to perform at least one of: null steering, altering a transmission beam of the first UE, or altering a reception beam of the first UE.

Some aspects described herein relate to a UE for wireless communication. The UE may include one or more memories and one or more processors coupled to the one or more memories. The one or more processors may be individually or collectively configured to transmit, to a network node, at least one communication parameter, the at least one communication parameter including at least a DOA estimate. The one or more processors may be individually or collectively configured to receive, from the network node, an interference indication that indicates the UE is to perform at least one of: null steering, altering a transmission beam of the UE, or altering a reception beam of the UE.

Some aspects described herein relate to a non-transitory computer-readable medium that stores a set of instructions for wireless communication by a network node. The set of instructions, when executed by one or more processors of the network node, may cause the network node to identify, based on a schedule of upcoming transmissions in a cell served by the network node, an upcoming intra-cell interference scenario between a first UE and a second UE. The set of instructions, when executed by one or more processors of the network node, may cause the network node to transmit, to the first UE, an interference indication that indicates the first UE is to perform at least one of: null steering, altering a transmission beam of the first UE, or altering a reception beam of the first UE.

Some aspects described herein relate to a non-transitory computer-readable medium that stores a set of instructions for wireless communication by a UE. The set of instructions, when executed by one or more processors of the UE, may cause the UE to transmit, to a network node, at least one communication parameter, the at least one communication parameter including at least a DOA estimate. The set of instructions, when executed by one or more processors of the UE, may cause the UE to receive, from the network node, an interference indication that indicates the UE is to perform at least one of: null steering, altering a transmission beam of the UE, or altering a reception beam of the UE.

Some aspects described herein relate to an apparatus for wireless communication. The apparatus may include means for identifying, based on a schedule of upcoming transmissions in a cell served by the network node, an upcoming intra-cell interference scenario between a first UE and a second UE. The apparatus may include means for transmitting, to the first UE, an interference indication that indicates the first UE is to perform at least one of: null steering, altering a transmission beam of the first UE, or altering a reception beam of the first UE.

Some aspects described herein relate to an apparatus for wireless communication. The apparatus may include means for transmitting, to a network node, at least one communication parameter, the at least one communication parameter including at least a DOA estimate. The apparatus may include means for receiving, from the network node, an interference indication that indicates the apparatus is to perform at least one of: null steering, altering a transmission beam of the apparatus, or altering a reception beam of the apparatus.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of channel state information reference signal (CSI-RS) beam management procedures, in accordance with the present disclosure.

FIG. 4 is a diagram illustrating examples relating to user equipment (UE)-to-UE cross link interference (CLI), in accordance with the present disclosure.

FIG. 5 is a diagram of an example associated with intra-cell interference mitigation, in accordance with the present disclosure.

FIG. 6 is a diagram illustrating an example process performed, for example, at a network node or an apparatus of a network node, in accordance with the present disclosure.

FIG. 7 is a diagram illustrating an example process performed, for example, at a UE or an apparatus of a UE, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Advancements in wireless communications have led to an increased number of devices that communicate via cellular networks (e.g., via 5G and 6G networks, among other examples). The introduction of multi-user multiple input multiple output (MU-MIMO) technology has enabled supported devices, including network nodes and some user equipment (UE) devices, to communicate with one another simultaneously using multiple antennas and using the same time and frequency resources. However, in certain situations, the use of MU-MIMO may increase the likelihood of intra-cell interference. Intra-cell interference arises when the communication paths between the network node and multiple UEs overlap, which may cause a reduction in communications quality (e.g., a reduction in a signal-to-noise ratio (SNR)), which could limit data transmission rates. Some networks with spatial multiplexing mechanisms aim to mitigate this interference to an extent, but may be less effective in dynamic scenarios where dynamic time division duplexing (TDD) or full duplexing are used, where UEs may not operate exclusively in uplink or downlink modes. In such scenarios, the intra-cell interference may not be addressed by existing methods, which may result in reduced communications quality (e.g., reduced SNR) and/or suboptimal data rates. In addition, intra-cell interference may be accentuated in higher frequency bands such as FR2 and sub-Terahertz (sub-THz), where the effects of path loss on non-line-of-sight (NLOS) beams are more pronounced, giving rise to directional interference patterns.

Various aspects relate generally to intra-cell interference mitigation. Some aspects more specifically relate to a network node using a schedule of upcoming transmissions to identify intra-cell interference and transmitting indications to a UE to mitigate the intra-cell interference. For example, a network node may identify, based on a schedule of upcoming transmissions, a potential intra-cell interference scenario between two UEs, and transmit to one of the UEs, an interference indication. The interference indication may indicate that the UE is to perform one or more actions, such as null steering, altering a transmission beam of the UE, or altering a reception beam of the UE, to mitigate potential interference.

In some aspects, the network node may request and receive capability information from UEs regarding null steering capabilities or direction of arrival (DOA) capabilities. Furthermore, the network node may request and receive additional communication parameters from UEs, such as DOA estimates and UE location data, and the network node may use the additional communication parameters to refine interference predictions and strategy for interference mitigation.

Particular aspects of the subject matter described in this disclosure can be implemented to realize one or more of the following potential advantages. In some examples, by identifying potential intra-cell interference scenarios in advance and communicating interference indications to affected UEs, the described techniques facilitate preemptive interference management. The timely alterations in beam patterns by UEs, as directed by interference indications, enable the network node to optimize spectrum utilization. As a result, this approach may conserve network resources by improving SNR and facilitating high data transmission rates. In addition, the reduction in interference may result in a reduction in retransmissions, which conserves processing resources, memory resources, and/or network bandwidth, among other examples.

In aspects where the network node obtains DOA estimates and UE location data, the ability to dynamically prepare an interference mitigation strategy may allow the network to adapt to real-time variations in the cell environment and may reduce the unnecessary expenditure of network resources on ineffective interference management, further conserving processing resources, memory resources, and/or network bandwidth, among other examples for the network node and UEs.

In some aspects, the network node may obtain UE capability information indicating parameters such as the maximum number of directions available for null steering, the maximum width associated with the null steering, and an expected quality parameter associated with DOA estimation. The UE capabilities enable the network node to make informed decisions about interference mitigation strategies tailored to the specific capabilities of each UE. For instance, the maximum number of directions available for null steering and the corresponding widths enable the network node to effectively direct UEs to steer beams to minimize interference in a more granular manner. Additionally, the expected quality parameter associated with DOA estimation may indicate how much weight the network node should place on the DOA estimates provided by the UEs for predicting interference scenarios and optimizing beam configurations. The granular level of UE capability information may enhance the precision and efficiency of interference management, reduce unnecessary processing and communication overhead, and facilitate optimization of spectral efficiency while promoting high data transmission rates.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

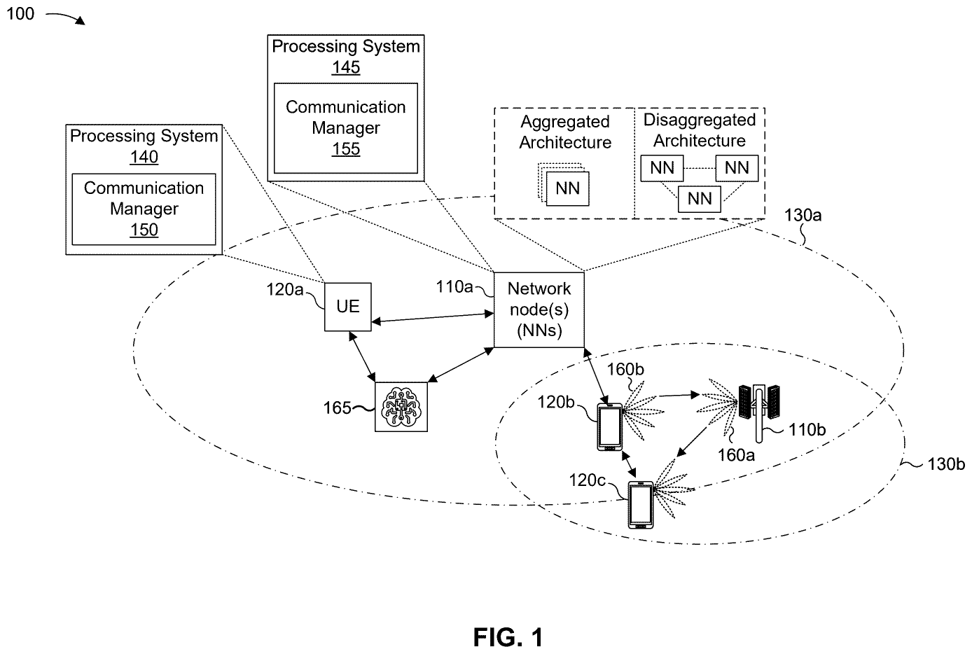

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

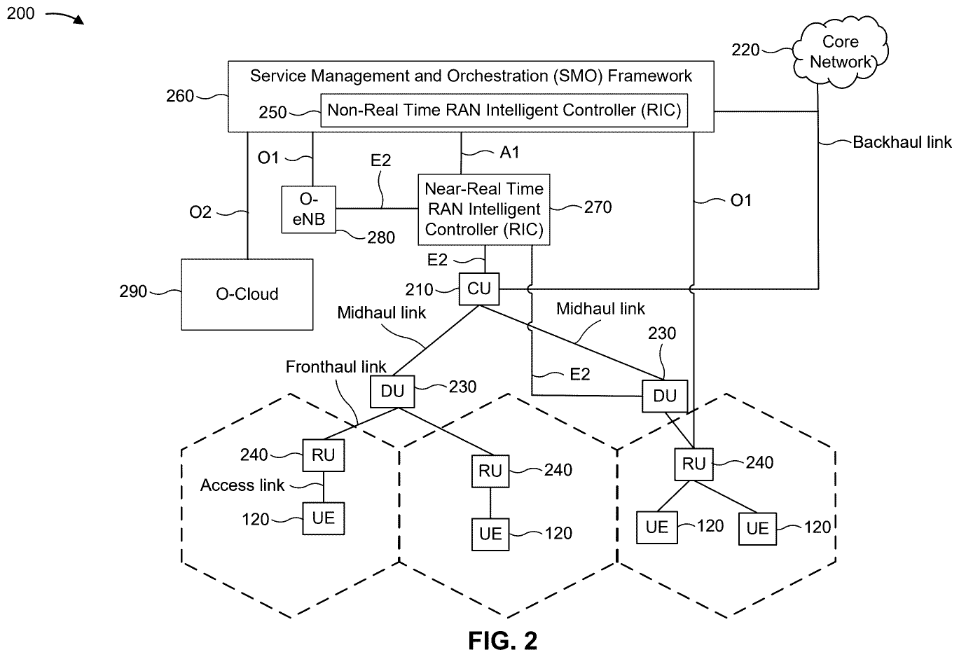

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (SS) (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as MU-MIMO. Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the network node 110 may include a communication manager 155. As described in more detail elsewhere herein, the communication manager 155 may identify, based on a schedule of upcoming transmissions in a cell served by the network node, an upcoming intra-cell interference scenario between a first UE and a second UE; and transmit, to the first UE, an interference indication that indicates the first UE is to perform at least one of: null steering, altering a transmission beam of the first UE, or altering a reception beam of the first UE. Additionally, or alternatively, the communication manager 155 may perform one or more other operations described herein.

In some aspects, the UE 120 may include a communication manager 150. As described in more detail elsewhere herein, the communication manager 150 may transmit, to a network node, at least one communication parameter, the at least one communication parameter including at least a DOA estimate; and receive, from the network node, an interference indication that indicates the UE is to perform at least one of: null steering, altering a transmission beam of the UE, or altering a reception beam of the UE. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

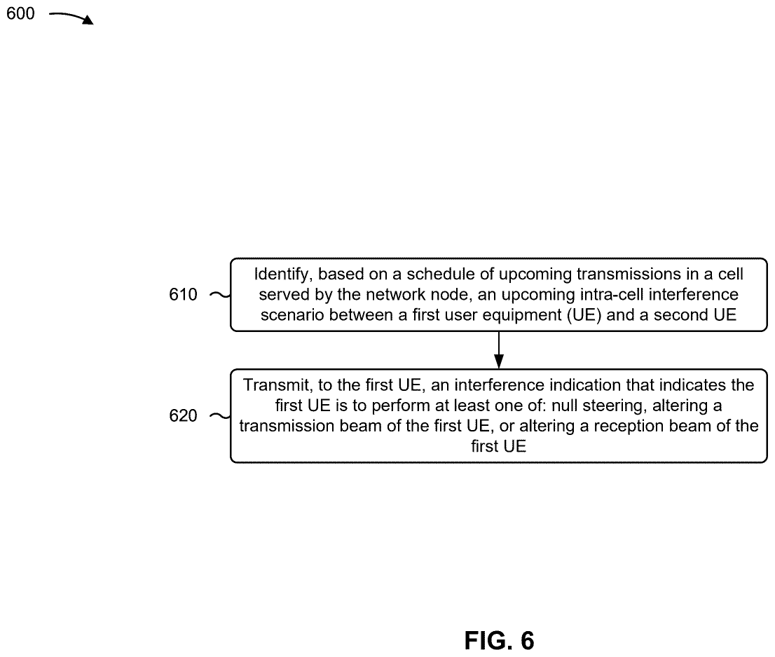

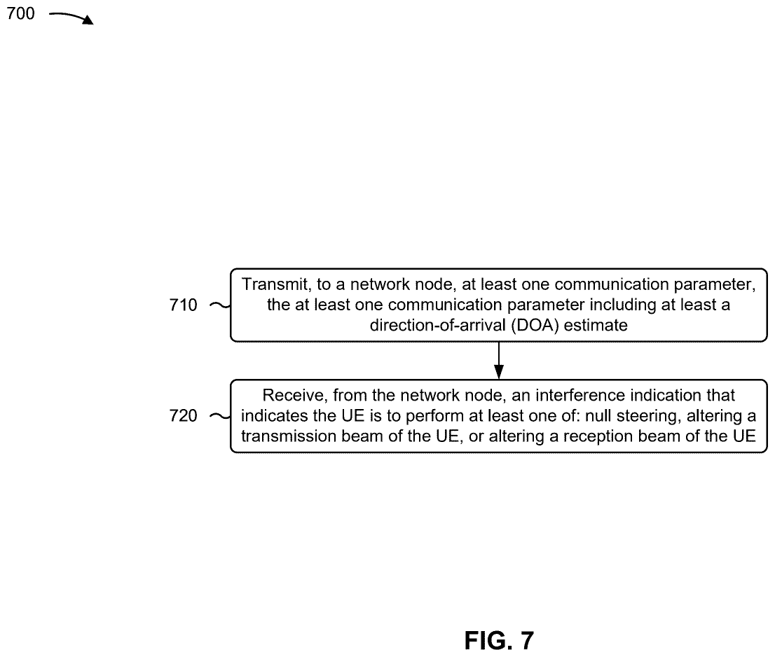

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with intra-cell interference mitigation, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, and/or interpreting the instructions, among other examples.

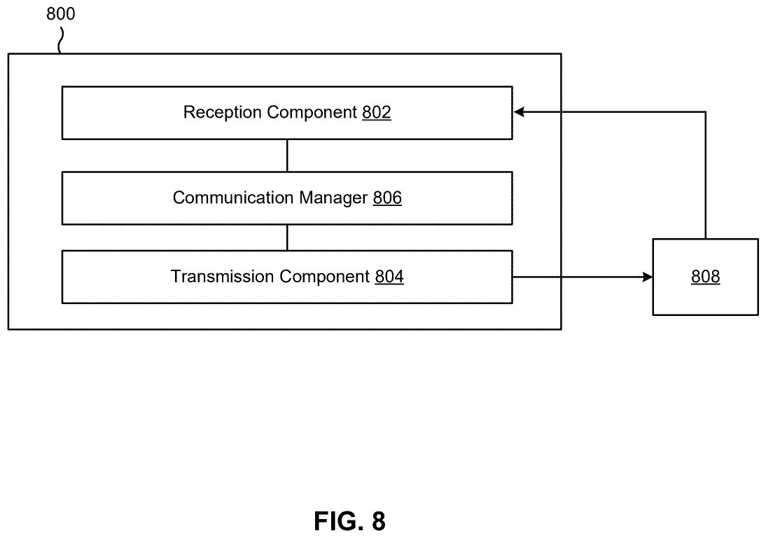

In some aspects, the network node (e.g., network node 110) includes means for identifying, based on a schedule of upcoming transmissions in a cell served by the network node, an upcoming intra-cell interference scenario between a first UE and a second UE; and/or means for transmitting, to the first UE, an interference indication that indicates the first UE is to perform at least one of: null steering, altering a transmission beam of the first UE, or altering a reception beam of the first UE. The means for the network node to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

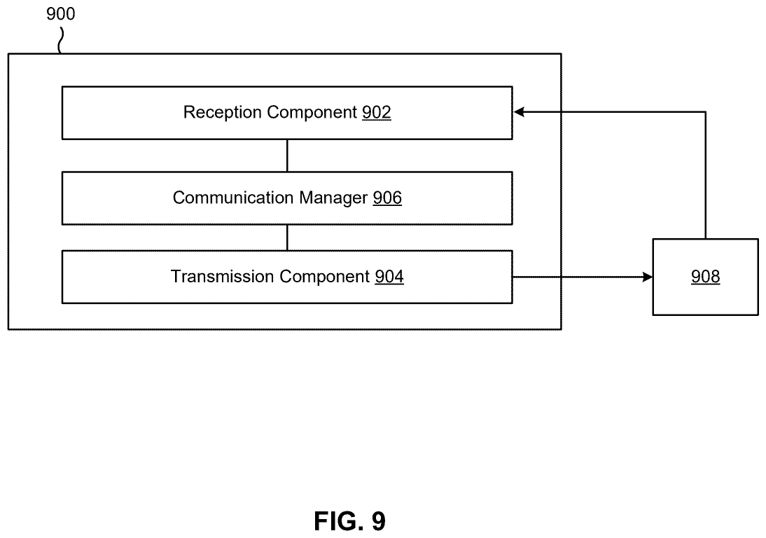

In some aspects, the UE (e.g., UE 120) includes means for transmitting, to a network node, at least one communication parameter, the at least one communication parameter including at least a DOA estimate; and/or means for receiving, from the network node, an interference indication that indicates the UE is to perform at least one of: null steering, altering a transmission beam of the UE, or altering a reception beam of the UE. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

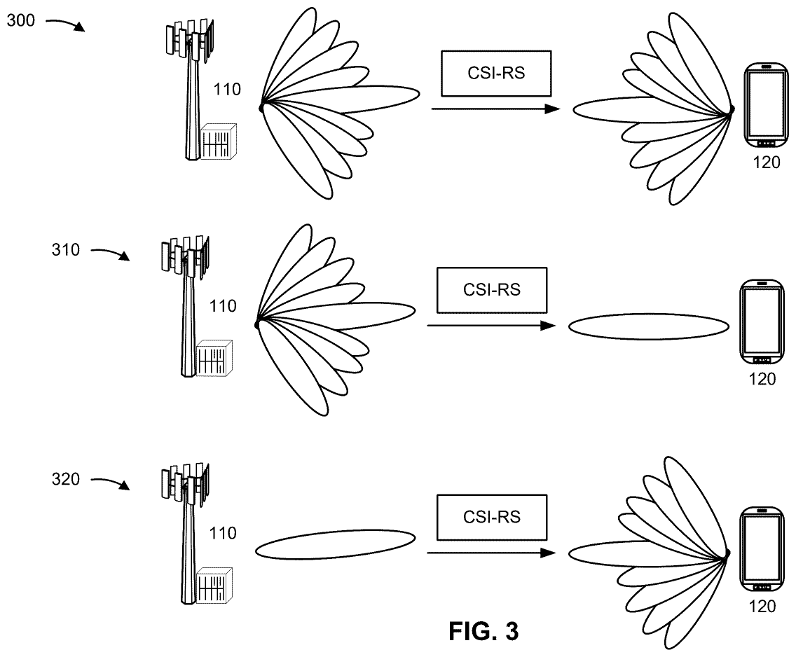

FIG. 3 is a diagram illustrating examples 300, 310, and 320 of CSI-RS beam management procedures, in accordance with the present disclosure. As shown in FIG. 3, examples 300, 310, and 320 include a UE 120 in communication with a network node 110 in a wireless network (e.g., wireless network 100). However, the devices shown in FIG. 3 are provided as examples, and the wireless network may support communication and beam management between other devices (e.g., between a UE 120 and a network node 110 or TRP, between a mobile termination node and a control node, between an IAB child node and an IAB parent node, and/or between a scheduled node and a scheduling node). In some aspects, the UE 120 and the network node 110 may be in a connected state (e.g., an RRC connected state).

As shown in FIG. 3, example 300 may include a network node 110 (e.g., one or more network node devices such as an RU, a DU, and/or a CU, among other examples) and a UE 120 communicating to perform beam management using CSI-RSs. Example 300 depicts a first beam management procedure (e.g., P1 CSI-RS beam management). The first beam management procedure may be referred to as a beam selection procedure, an initial beam acquisition procedure, a beam sweeping procedure, a cell search procedure, and/or a beam search procedure. As shown in FIG. 3 and example 300, CSI-RSs may be configured to be transmitted from the network node 110 to the UE 120. The CSI-RSs may be configured to be periodic (e.g., using RRC signaling), semi-persistent (e.g., using MAC-CE signaling), and/or aperiodic (e.g., using DCI).

The first beam management procedure may include the network node 110 performing beam sweeping over multiple transmit (Tx) beams. The network node 110 may transmit a CSI-RS using each transmit beam for beam management. To enable the UE 120 to perform receive (Rx) beam sweeping, the network node may use a transmit beam to transmit (e.g., with repetitions) each CSI-RS at multiple times within the same RS resource set so that the UE 120 can sweep through receive beams in multiple transmission instances. For example, if the network node 110 has a set of N transmit beams and the UE 120 has a set of M receive beams, the CSI-RS may be transmitted on each of the N transmit beams M times so that the UE 120 may receive M instances of the CSI-RS per transmit beam. In other words, for each transmit beam of the network node 110, the UE 120 may perform beam sweeping through the receive beams of the UE 120. As a result, the first beam management procedure may enable the UE 120 to measure a CSI-RS on different transmit beams using different receive beams to support selection of network node 110 transmit beams/UE 120 receive beam(s) beam pair(s). The UE 120 may report the measurements to the network node 110 to enable the network node 110 to select one or more beam pair(s) for communication between the network node 110 and the UE 120. While example 300 has been described in connection with CSI-RSs, the first beam management process may also use SSBs for beam management in a similar manner as described above.

As shown in FIG. 3, example 310 may include a network node 110 and a UE 120 communicating to perform beam management using CSI-RSs. Example 310 depicts a second beam management procedure (e.g., P2 CSI-RS beam management). The second beam management procedure may be referred to as a beam refinement procedure, a network node beam refinement procedure, a TRP beam refinement procedure, and/or a transmit beam refinement procedure. As shown in FIG. 3 and example 310, CSI-RSs may be configured to be transmitted from the network node 110 to the UE 120. The CSI-RSs may be configured to be aperiodic (e.g., using DCI). The second beam management procedure may include the network node 110 performing beam sweeping over one or more transmit beams. The one or more transmit beams may be a subset of all transmit beams associated with the network node 110 (e.g., determined based at least in part on measurements reported by the UE 120 in connection with the first beam management procedure). The network node 110 may transmit a CSI-RS using each transmit beam of the one or more transmit beams for beam management. The UE 120 may measure each CSI-RS using a single (e.g., a same) receive beam (e.g., determined based at least in part on measurements performed in connection with the first beam management procedure). The second beam management procedure may enable the network node 110 to select a best transmit beam based at least in part on measurements of the CSI-RSs (e.g., measured by the UE 120 using the single receive beam) reported by the UE 120.

As shown in FIG. 3, example 320 depicts a third beam management procedure (e.g., P3 CSI-RS beam management). The third beam management procedure may be referred to as a beam refinement procedure, a UE beam refinement procedure, and/or a receive beam refinement procedure. As shown in FIG. 3 and example 320, one or more CSI-RSs may be configured to be transmitted from the network node 110 to the UE 120. The CSI-RSs may be configured to be aperiodic (e.g., using DCI). The third beam management process may include the network node 110 transmitting the one or more CSI-RSs using a single transmit beam (e.g., determined based at least in part on measurements reported by the UE 120 in connection with the first beam management procedure and/or the second beam management procedure). To enable the UE 120 to perform receive beam sweeping, the network node may use a transmit beam to transmit (e.g., with repetitions) CSI-RS at multiple times within the same RS resource set so that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the network node 110 and/or the UE 120 to select a best receive beam based at least in part on reported measurements received from the UE 120 (e.g., of the CSI-RS of the transmit beam using the one or more receive beams).

In addition to participating in beam selection procedures for the selection of the best transmit/receive beams, a network node may also configure a UE to perform other beam management or beam-related operations, such as altering beams and/or performing null steering. Beams may be altered in a variety of ways that may affect performance and quality of communications. For example, beam phase and amplitude values may be altered, beam weights may be altered, beam power levels may be altered, and/or a number of beams used may be altered, among other examples. In some aspects, a UE may also be capable of performing null steering, where points of minimal strength, or nulls, are pointed in specific directions to reduce interference from unwanted signals. While both UEs and network nodes are capable of performing their own beam management procedures, in some aspects, the network node may cause a UE to perform one or more beam management procedures, as described further herein.

As indicated above, FIG. 3 is provided as an example of beam management procedures. Other examples of beam management procedures may differ from what is described with respect to FIG. 3. For example, the UE 120 and the network node 110 may perform the third beam management procedure before performing the second beam management procedure, and/or the UE 120 and the network node 110 may perform a similar beam management procedure to select a UE transmit beam.

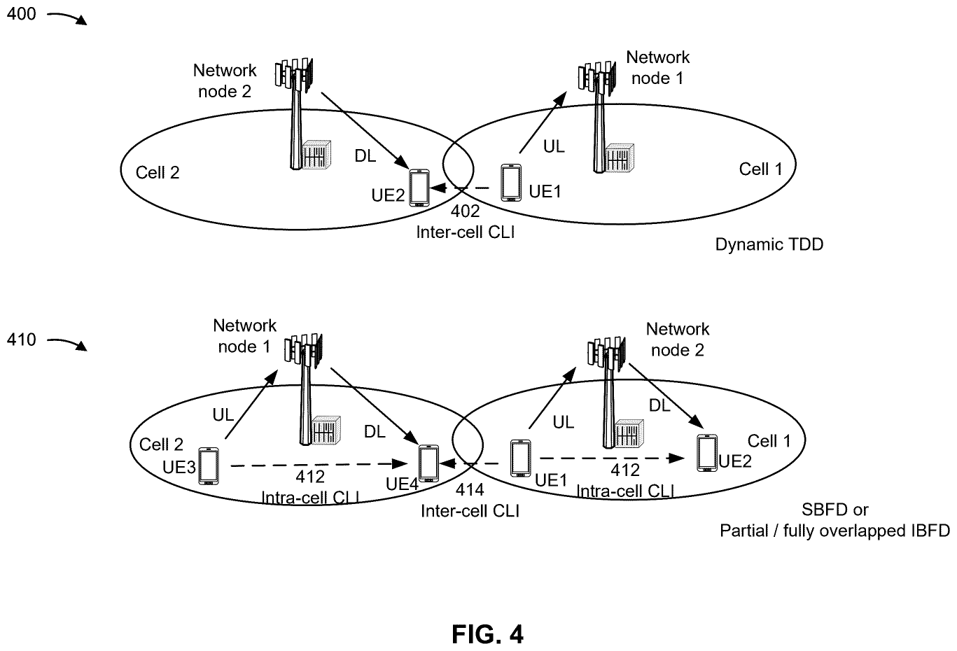

FIG. 4 is a diagram illustrating examples 400 and 410 relating to UE-to-UE cross link interference (CLI), in accordance with the present disclosure.

Example 400 shows an example of dynamic TDD communication. As shown in example 400, when dynamic TDD is implemented, neighboring cells (cell 1 and cell 2) may use different TDD configurations to communicate with UEs, which may result in an uplink communication between a first UE (UE1) and a first network node (network node 1) in a same transmission time interval (TTI) as a downlink communication between a second network node (network node 2) and a second UE (UE2). These communications in different transmission directions (for example, downlink versus uplink) in the same TTI may interfere with one another, which may be referred to as CLI. Interference with reception of a downlink communication by one UE caused by transmission of an uplink communication by another UE may be referred to as UE-to-UE CLI or inter-UE CLI.

For example, as shown by reference number 402, in the dynamic TDD scenario, transmission of the uplink communication in a symbol or a slot by UE1 in cell 1 may interfere with reception of the downlink communication in the symbol or the slot by UE2 in cell 2. Such interference may be referred to as inter-cell UE-to-UE CLI or inter-cell inter-UE CLI.

Example 410 shows an example of full-duplex (FD) communication, such as SBFD, fully overlapping in-band full-duplex (IBFD), or partial overlapping IBFD. As shown by reference number 412, in an FD scenario, transmission of an uplink communication in an SBFD or IBFD slot or symbol by one UE in a cell may interfere with reception of a downlink communication in the SBFD or IBFD slot or symbol by another UE in the cell. For example, transmission of an uplink communication in an SBFD or IBFD slot or symbol by a first UE (UE1) in a first cell (cell 1) may interfere with reception of a downlink communication in the SBFD or IBFD slot or symbol by a second UE (UE2) in cell 1. As another example, transmission of an uplink communication in an SBFD or IBFD slot or symbol by a third UE (UE3) in a second cell (cell 2) may interfere with reception of a downlink communication in the SBFD or IBFD slot or symbol by a fourth UE (UE4) in cell 2. Such interference may be referred to as intra-cell UE-to-UE CLI or intra-cell inter-UE CLI. In an SBFD scenario, transmission of an uplink communication on an uplink sub-band (SB) in an SBFD symbol or slot by one UE (for example, UE1) in a cell (for example, cell 1) may interfere with reception of a downlink communication on a downlink SB in the SBFD symbol or slot by another UE (for example, UE2) in the cell. Such interference may be referred to as inter-SB intra-cell UE-to-UE CLI or inter-SB intra-cell inter-UE CLI.

As shown by reference number 414, in an FD scenario, transmission of an uplink communication in an SBFD or an IBFD symbol or slot by UE1 in cell 1 may interfere with reception of a downlink communication in the SBFD of IBFD symbol or slot by UE4 in cell 2. Such interference may be referred to as inter-cell inter-UE CLI. In an SBFD scenario, transmission of an uplink communication on an uplink SB in an SBFD symbol or slot by UE1 in cell 1 may interfere with reception of a downlink communication on a downlink SB in the SBFD symbol or slot by UE4 in cell 2. Such interference may be referred to as inter-SB inter-cell inter-UE CLI.

As indicated above, FIG. 4 is provided as an example. Other examples may differ from what is described with regard to FIG. 4.

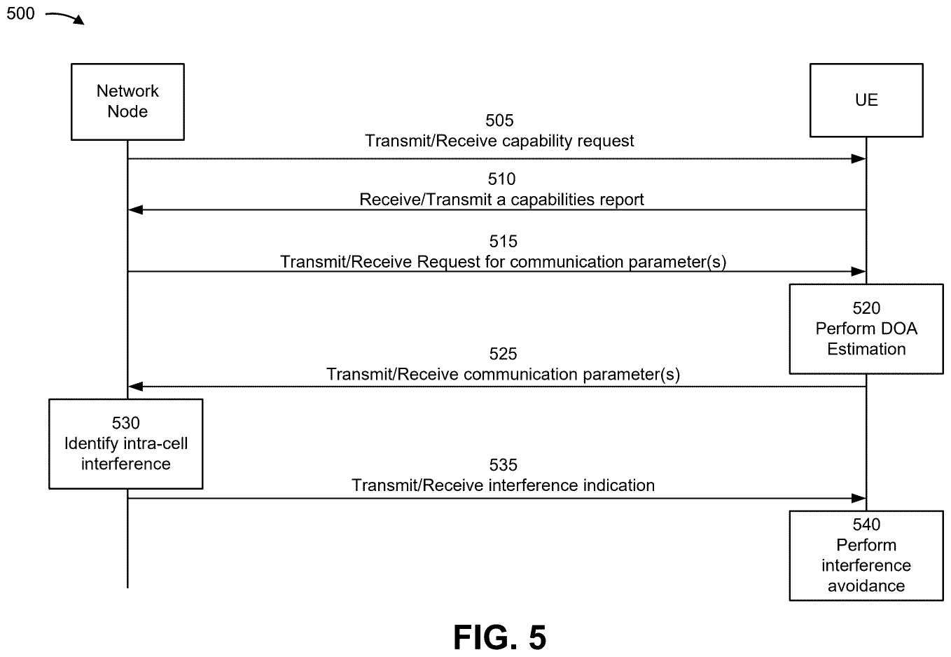

FIG. 5 is a diagram of an example 500 associated with intra-cell interference mitigation, in accordance with the present disclosure. As shown in FIG. 5, a network node (e.g., network node 110, a CU, a DU, and/or an RU) may communicate with a UE (e.g., UE 120). In some aspects, the network node and the UE may be part of a wireless network (e.g., wireless communication network 100). The UE and the network node may have established a wireless connection prior to operations shown in FIG. 5.

As shown by reference number 505, the network node may transmit, and the UE may receive, a capability request. In some aspects, the capability request may be a request for null steering and/or DOA estimation capabilities of the UE. The capability request may be transmitted via one or more of system information (e.g., a master information block (MIB) and/or a system information block (SIB), among other examples), RRC signaling, one or more MAC-CEs, and/or DCI, among other examples.

As shown by reference number 510, the UE may transmit, and the network node may receive, a capabilities report. The capabilities report may indicate whether the UE supports a feature and/or one or more parameters related to the feature. For example, the capabilities report may indicate a capability and/or parameter for null steering. As another example, the capabilities report may indicate a capability and/or parameter for DOA estimation. One or more operations described herein may be based on capability information of the capabilities report. For example, the UE may perform a communication in accordance with the capability information, or may receive configuration information that is in accordance with the capability information. In some aspects, the capabilities report may include capability information indicating a maximum number of directions available for null steering, a maximum width associated with the null steering (e.g., angular width in degrees for each null), or an expected quality parameter associated with DOA estimation (e.g., an expected resolution and/or accuracy of the DOA estimation).

As described herein, a null steering capability indicates the UE has the capability to direct points of minimal strength, or nulls, in a specific direction or directions, which may facilitate mitigating interference in the direction(s) of null steering. The DOA estimation capability indicates that the UE is capable of determining the direction from which a received signal was transmitted, often using multiple antennas or sensor arrays. For example, methods for DOA estimation include multiple signal classification (MUSIC), minimum variance distortionless response (MVDR), and estimation of signal parameters via rotational invariance techniques (ESPRIT), among other examples.

In some aspects, the capabilities report may be transmitted via MAC-CE, e.g., at the beginning of communications between the network node and UE. In some aspects, the capabilities report may be transmitted via uplink control information (UCI) as part of a physical uplink control channel (PUCCH) communication. For example, in a situation where the UE capabilities have changed (e.g., due to low batter mode and/or changing number of active antennas, among other examples), the UE may transmit the capabilities report to update the network node as to the current capabilities of the UE.

As shown by reference number 515, the network node may transmit, and the UE may receive, a request for one or more communication parameters. For example, the request may include a request for a DOA estimate and/or a request for UE location data. A DOA estimate and/or UE location data may be requested by the network node to enable the network node to identify potential intra-cell interference, as described further herein. In some aspects, the network node may transmit the request for a DOA estimate only to UEs that have indicated support for the DOA estimation capability. The request for communication parameters may, in some aspects, be transmitted via DCI as part of a PDCCH communication.

By way of example, the network node may request that a UE with DOA estimation capabilities perform DOA estimation in association with particular network resources, such as specific slots. The network node may also instruct another UE to transmit uplink data in association with the same resources (e.g., in the same slots). By instructing one UE to transmit while one or more other UEs perform DOA estimation, the network node may determine whether, and to what degree, the transmitting UE would interfere with any of the other UEs performing DOA estimation. When combined with UE location data, the DOA estimation data may be used to generate an interference map of a cell served by the network node. In some aspects, the interference map, combined with scheduling information, may enable the network node to track and predict intra-cell interference within the cell.

As shown by reference number 520, the UE may perform DOA estimation. Additionally, or alternatively, the UE may also identify location data indicating a location of the UE. For example, based at least in part on receiving the request for one or more communication parameters from the network node, the UE may identify the one or more parameters (e.g., a DOA estimate and/or UE location data) by performing a DOA estimate and/or obtaining data indicating a location of the UE.

As described herein, the UE may use a DOA estimation technique, such as MUSIC, MVDR, and/or ESPRIT, among other examples. If within the UE's capabilities, the UE may also determine, with the DOA estimate, a direction of interference (e.g., an angle and width), a power of measured signal (e.g., RSSI) to indicate a magnitude of the interference, and/or an expected quality parameter (e.g., expected resolution and/or accuracy of the DOA estimation), among other examples.

As shown by reference number 525, the UE may transmit, and the network node may receive, one or more communication parameters. For example, the one or more communication parameters may include the DOA estimate (e.g., with additional parameters identified as part of the DOA estimate) and/or location data indicating a location of the UE, among other examples. In some aspects, the one or more communication parameters may be transmitted in an interference information report via UCI as part of a PUCCH communication.

As shown by reference number 530, the network node may identify an intra-cell interference scenario. For example, based on a schedule of upcoming transmissions in a cell served by the network node, the network node may identify an intra-cell interference scenario between a first UE and a second UE. In some aspects, the network node may identify the intra-cell interference scenario based on the one or more communication parameters, such as a network node DOA estimate, one or more UE DOA estimates, or UE location information. For example, with DOA estimates and UE location information indicating which UEs might interfere with one another, and where those UEs are located, the network node may identify potential interference between the first and second UEs.

In some aspects, the network node may identify the upcoming intra-cell interference scenario based on an interference map that identifies the one or more communication parameters. For example, the interference map may include, for one or more UEs in the cell, UE location data, DOA estimates including direction, width, and magnitude of interference along with an expected quality parameter (e.g., a confidence score). Combined with a schedule of upcoming transmissions that indicates transmission patterns and resource allocations with the cell, the network node may identify potential upcoming interference between the first and second UEs. In some aspects, the network node may also perform sensing within its own area to identify potential interference, and the network node estimates may be included in the interference map. For example, the network node may use radar to detect beams associated with different UEs and/or machine learning sensing tools designed to learn the cell's environment, among other examples.

In some aspects, the network node may identify the upcoming intra-cell interference scenario in a portion of the cell associated with UEs that communicate via MU-MIMO. For example, UEs that communicate with the network node using MU-MIMO may be more likely to cause interference (e.g., because they may communicate more often than and/or in overlapping resources with other UEs) and, in some situations, the UEs may be more capable of mitigating intra-cell interference (e.g., due to beam management capabilities that are enabled by the use of multiple antennas). In this situation, the network node may focus attention on potential interference in areas with UEs that communicate via MU-MIMO in order to more efficiently identify interference in the cell.

In some aspects, the network node identifies an upcoming intra-cell interference scenario only when the identified interference is identified as limiting. Limiting interference may be interference that satisfies a particular threshold. In some aspects, interference threshold may be a predefined SNR level that, if exceeded, triggers interference mitigation procedures. For example, the network node may identify interference as limiting when the potential interference strength is on a same order of magnitude as a SNR reported by a victim UE (e.g., the UE to be interfered with).

As shown by reference number 535, the network node may transmit, and the UE may receive, an interference indication. In some aspects, the interference indication may be transmitted via DCI as part of a PDCCH communication. The interference indication may indicate that the UE is to perform null steering, altering a transmission beam, or altering a reception beam. For example, in a situation where the UE is a victim UE with null steering capability, the network node may indicate that the UE is to perform null steering in a direction associated with the interference to mitigate the interference. In some aspects, the indication may indicate one or more particular beams, a direction, and/or a width associated with the null steering. As another example, in a situation where the UE is a victim UE without null steering capability, the network node may indicate that the UE is to alter a reception beam (e.g., switch reception beams, modify weights, power levels, phase, amplitude, and/or a number of reception beams, among other examples). Additionally, or alternatively, in a situation where the UE is an aggressor UE (e.g., with a transmission causing interference), the network node may indicate that the UE is to alter the transmission beam (e.g., switch transmission beams, modify weights, power levels, phase, amplitude, and/or a number of transmission beams, among other examples).

In some aspects, the network node may prioritize interference mitigation indications. For example, the network node may prefer to first mitigate interference via null steering, if available. Second, if available, the network node may prefer to modify a transmission beam. Lastly, the network node may indicate to modify a reception beam. The prioritization of interference mitigation may depend on a variety of factors. Example factors may include a quality of service associated with communications, a communication priority assigned to one or more communications, and/or whether the amount of degradation experienced by performing interference mitigation will exceed the degradation experienced by the interference, among other examples.

As shown by reference number 540, the UE may perform an action associated with interference avoidance. For example, the UE may perform null steering, altering a transmission beam, or altering a reception beam, to mitigate upcoming interference, as described herein. In some aspects, an indicated direction associated with the interference is indicated via an index of directions. For example, the network node and UE may use a configured look-up table with indices mapped to particular directions. As another example the direction may be indicated by providing an angle and width value. In some aspects, if a beam change is indicated, the interference indication may indicate a beam index to which the UE should switch. As described herein, the action performed by the UE is in accordance with the indication received by the network node and is designed to mitigate interference between the UE and another UE in the cell.

As indicated above, FIG. 5 is provided as an example. Other examples may differ from what is described with respect to FIG. 5.

As described herein, by identifying potential intra-cell interference scenarios in advance and communicating interference indications to affected UEs, the described techniques facilitate preemptive interference management. The timely alterations in beam patterns by UEs, as directed by interference indications, enable the network node to optimize spectrum utilization. As a result, this approach may conserve network resources by improving SNR and facilitating high data transmission rates. In addition, the reduction in interference may result in a reduction in retransmissions, which conserves processing resources, memory resources, and/or network bandwidth, among other examples.

In aspects where the network node obtains DOA estimates and UE location data, the ability to dynamically prepare an interference mitigation strategy may allow the network to adapt to real-time variations in the cell environment and may reduce the unnecessary expenditure of network resources on ineffective interference management, further conserving processing resources, memory resources, and/or network bandwidth, among other examples for the network node and UEs.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with intra-cell interference mitigation.

As shown in FIG. 6, in some aspects, process 600 may include identifying, based on a schedule of upcoming transmissions in a cell served by the network node, an upcoming intra-cell interference scenario between a first UE and a second UE (block 610). For example, the network node (e.g., using communication manager 806, depicted in FIG. 8) may identify, based on a schedule of upcoming transmissions in a cell served by the network node, an upcoming intra-cell interference scenario between a first UE and a second UE, as described above.

As further shown in FIG. 6, in some aspects, process 600 may include transmitting, to the first UE, an interference indication that indicates the first UE is to perform at least one of: null steering, altering a transmission beam of the first UE, or altering a reception beam of the first UE (block 620). For example, the network node (e.g., using transmission component 804 and/or communication manager 806, depicted in FIG. 8) may transmit, to the first UE, an interference indication that indicates the first UE is to perform at least one of: null steering, altering a transmission beam of the first UE, or altering a reception beam of the first UE, as described above.

Process 600 may include additional aspects, such as any single aspect or any combination of aspects described below and/or in connection with one or more other processes described elsewhere herein.

In a first aspect, process 600 includes transmitting, to at least one UE in the cell, a request for capability information indicating, for the at least one UE, at least one of a null steering capability or DOA capability.

In a second aspect, alone or in combination with the first aspect, process 600 includes receiving, from at least one UE in the cell, capability information indicating, for the at least one UE, at least one of a null steering capability or DOA capability.

In a third aspect, alone or in combination with one or more of the first and second aspects, the capability information further indicates at least one of a maximum number of directions available for null steering, a maximum width associated with the null steering, or an expected quality parameter associated with DOA estimation.

In a fourth aspect, alone or in combination with one or more of the first through third aspects, process 600 includes transmitting, to at least one UE in the cell, a request for at least one communication parameter associated with the cell, and receiving, from the at least one UE, the at least one communication parameter.

In a fifth aspect, alone or in combination with one or more of the first through fourth aspects, the at least one communication parameter comprises one or more of a DOA estimate, or data indicating a UE location associated with the at least one UE.

In a sixth aspect, alone or in combination with one or more of the first through fifth aspects, the DOA estimate includes at least one of a power estimate of an interference signal detected by the at least one UE, a direction associated with the interference signal, or a beam width associated with the interference signal.

In a seventh aspect, alone or in combination with one or more of the first through sixth aspects, identifying the upcoming intra-cell interference scenario further comprises identifying the upcoming intra-cell interference scenario based on one or more communication parameters, the one or more communication parameters including at least one of a network node DOA estimate, one or more UE DOA estimates, or UE location information.

In an eighth aspect, alone or in combination with one or more of the first through seventh aspects, identifying the upcoming intra-cell interference scenario further comprises identifying the upcoming intra-cell interference scenario further based on an interference map that identifies the one or more communication parameters.

In a ninth aspect, alone or in combination with one or more of the first through eighth aspects, identifying the upcoming intra-cell interference scenario further comprises identifying the upcoming intra-cell interference scenario in a portion of the cell associated with UEs that communicate via MU-MIMO.

In a tenth aspect, alone or in combination with one or more of the first through ninth aspects, transmitting the interference indication comprises transmitting the interference indication based on the upcoming intra-cell interference scenario being associated with an amount of interference that satisfies an interference threshold.

In an eleventh aspect, alone or in combination with one or more of the first through tenth aspects, the first UE is scheduled to receive a communication associated with the upcoming intra-cell interference scenario, and the interference indication indicates that the first UE is to perform null steering in an indicated direction, or altering the reception beam associated with the indicated direction.

In a twelfth aspect, alone or in combination with one or more of the first through eleventh aspects, the indicated direction is indicated via an index of directions.

In a thirteenth aspect, alone or in combination with one or more of the first through twelfth aspects, the interference indication includes information identifying at least one beam index associated with the altering of the reception beam.

In a fourteenth aspect, alone or in combination with one or more of the first through thirteenth aspects, the first UE is scheduled to transmit a communication associated with the upcoming intra-cell interference scenario, and the interference indication indicates that the first UE is to alter the transmission beam associated with an indicated direction.

In a fifteenth aspect, alone or in combination with one or more of the first through fourteenth aspects, the interference indication includes information identifying at least one beam index associated with the alteration of the transmission beam.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with intra-cell interference mitigation.

As shown in FIG. 7, in some aspects, process 700 may include transmitting, to a network node, at least one communication parameter, the at least one communication parameter including at least a DOA estimate (block 710). For example, the UE (e.g., using transmission component 904 and/or communication manager 906, depicted in FIG. 9) may transmit, to a network node, at least one communication parameter, the at least one communication parameter including at least a DOA estimate, as described above.

As further shown in FIG. 7, in some aspects, process 700 may include receiving, from the network node, an interference indication that indicates the UE is to perform at least one of: null steering, altering a transmission beam of the UE, or altering a reception beam of the UE (block 720). For example, the UE (e.g., using reception component 902 and/or communication manager 906, depicted in FIG. 9) may receive, from the network node, an interference indication that indicates the UE is to perform at least one of: null steering, altering a transmission beam of the UE, or altering a reception beam of the UE, as described above.

Process 700 may include additional aspects, such as any single aspect or any combination of aspects described below and/or in connection with one or more other processes described elsewhere herein.

In a first aspect, process 700 includes receiving a request for capability information associated with at least one of a null steering capability or DOA capability.

In a second aspect, alone or in combination with the first aspect, process 700 includes transmitting capability information indicating, for the UE, at least one of a null steering capability or DOA capability.

In a third aspect, alone or in combination with one or more of the first and second aspects, the capability information further indicates at least one of a maximum number of directions available for null steering, a maximum width associated with the null steering, or an expected quality parameter associated with DOA estimation.

In a fourth aspect, alone or in combination with one or more of the first through third aspects, process 700 includes receiving a request for at least one communication parameter associated with the UE, wherein transmitting the at least one communication parameter comprises transmitting the at least one communication parameters in connection with receiving the request.

In a fifth aspect, alone or in combination with one or more of the first through fourth aspects, process 700 includes transmitting one or more updated communication parameters based on a condition being met.

In a sixth aspect, alone or in combination with one or more of the first through fifth aspects, the at least one communication parameter further comprises data indicating a UE location.

In a seventh aspect, alone or in combination with one or more of the first through sixth aspects, process 700 includes performing DOA estimation based on receiving the request for the at least one communication parameter.

In an eighth aspect, alone or in combination with one or more of the first through seventh aspects, the DOA estimate includes at least one of a power estimate of an interference signal detected by the UE, a direction associated with the interference signal, or a beam width associated with the interference signal.

In a ninth aspect, alone or in combination with one or more of the first through eighth aspects, the interference indication indicates that the UE is to perform null steering in an indicated direction, or altering the reception beam associated with the indicated direction.

In a tenth aspect, alone or in combination with one or more of the first through ninth aspects, the indicated direction is indicated via an index of directions.

In an eleventh aspect, alone or in combination with one or more of the first through tenth aspects, the interference indication includes information identifying at least one beam index associated with the alteration of the reception beam.

In a twelfth aspect, alone or in combination with one or more of the first through eleventh aspects, the UE is scheduled to transmit a communication, and the interference indication indicates that the UE is to alter the transmission beam associated with an indicated direction.

In a thirteenth aspect, alone or in combination with one or more of the first through twelfth aspects, the interference indication includes information identifying at least one beam index associated with the alteration of the transmission beam.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 3-5. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The communication manager 806 may identify, based on a schedule of upcoming transmissions in a cell served by the network node, an upcoming intra-cell interference scenario between a first UE and a second UE. The transmission component 804 may transmit, to the first UE, an interference indication that indicates the first UE is to perform at least one of: null steering, altering a transmission beam of the first UE, or altering a reception beam of the first UE.

The transmission component 804 may transmit, to at least one UE in the cell, a request for capability information indicating, for the at least one UE, at least one of a null steering capability or DOA capability.

The reception component 802 may receive, from at least one UE in the cell, capability information indicating, for the at least one UE, at least one of a null steering capability or DOA capability.

The transmission component 804 may transmit, to at least one UE in the cell, a request for at least one communication parameter associated with the cell.

The reception component 802 may receive, from the at least one UE, the at least one communication parameter.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 3-5. Additionally, or alternatively, the apparatus 900 may be configured to perform one or more processes described herein, such as process 700 of FIG. 7. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to a network node, at least one communication parameter, the at least one communication parameter including at least a DOA estimate. The reception component 902 may receive, from the network node, an interference indication that indicates the UE is to perform at least one of: null steering, altering a transmission beam of the UE, or altering a reception beam of the UE.

The reception component 902 may receive a request for capability information associated with at least one of a null steering capability or DOA capability.

The transmission component 904 may transmit capability information indicating, for the UE, at least one of a null steering capability or DOA capability.

The reception component 902 may receive a request for at least one communication parameter associated with the UE wherein transmitting the at least one communication parameter comprises transmitting the at least one communication parameters in connection with receiving the request.

The transmission component 904 may transmit one or more updated communication parameters based on a condition being met.

The communication manager 906 may perform DOA estimation based on receiving the request for the at least one communication parameter.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a network node, comprising: identifying, based on a schedule of upcoming transmissions in a cell served by the network node, an upcoming intra-cell interference scenario between a first UE and a second UE; and transmitting, to the first UE, an interference indication that indicates the first UE is to perform at least one of: null steering, altering a transmission beam of the first UE, or altering a reception beam of the first UE.

Aspect 2: The method of Aspect 1, further comprising: transmitting, to at least one UE in the cell, a request for capability information indicating, for the at least one UE, at least one of a null steering capability or DOA capability.

Aspect 3: The method of any of Aspects 1-2, further comprising: receiving, from at least one UE in the cell, capability information indicating, for the at least one UE, at least one of a null steering capability or DOA capability.

Aspect 4: The method of Aspect 3, wherein the capability information further indicates at least one of: a maximum number of directions available for null steering, a maximum width associated with the null steering, or an expected quality parameter associated with DOA estimation.

Aspect 5: The method of any of Aspects 1-4, further comprising: transmitting, to at least one UE in the cell, a request for at least one communication parameter associated with the cell; and receiving, from the at least one UE, the at least one communication parameter.

Aspect 6: The method of Aspect 5, wherein the at least one communication parameter comprises one or more of: a DOA estimate, or data indicating a UE location associated with the at least one UE.

Aspect 7: The method of Aspect 6, wherein the DOA estimate includes at least one of: a power estimate of an interference signal detected by the at least one UE, a direction associated with the interference signal, or a beam width associated with the interference signal.

Aspect 8: The method of any of Aspects 1-7, wherein identifying the upcoming intra-cell interference scenario further comprises: identifying the upcoming intra-cell interference scenario based on one or more communication parameters, the one or more communication parameters including at least one of: a network node DOA estimate, one or more UE DOA estimates, or UE location information.

Aspect 9: The method of Aspect 8, wherein identifying the upcoming intra-cell interference scenario further comprises: identifying the upcoming intra-cell interference scenario further based on an interference map that identifies the one or more communication parameters.

Aspect 10: The method of Aspect 8, wherein identifying the upcoming intra-cell interference scenario further comprises: identifying the upcoming intra-cell interference scenario in a portion of the cell associated with UEs that communicate via MU-MIMO.

Aspect 11: The method of any of Aspects 1-10, wherein transmitting the interference indication comprises: transmitting the interference indication based on the upcoming intra-cell interference scenario being associated with an amount of interference that satisfies an interference threshold.

Aspect 12: The method of any of Aspects 1-11, wherein the first UE is scheduled to receive a communication associated with the upcoming intra-cell interference scenario, and the interference indication indicates that the first UE is to perform: null steering in an indicated direction, or altering the reception beam associated with the indicated direction.

Aspect 13: The method of Aspect 12, wherein the indicated direction is indicated via an index of directions.

Aspect 14: The method of Aspect 12, wherein the interference indication includes information identifying at least one beam index associated with the altering of the reception beam.

Aspect 15: The method of any of Aspects 1-14, wherein the first UE is scheduled to transmit a communication associated with the upcoming intra-cell interference scenario, and the interference indication indicates that the first UE is to alter the transmission beam associated with an indicated direction.

Aspect 16: The method of Aspect 15, wherein the interference indication includes information identifying at least one beam index associated with the alteration of the transmission beam.

Aspect 17: A method of wireless communication performed by a UE, comprising: transmitting, to a network node, at least one communication parameter, the at least one communication parameter including at least a DOA estimate; and receiving, from the network node, an interference indication that indicates the UE is to perform at least one of: null steering, altering a transmission beam of the UE, or altering a reception beam of the UE.

Aspect 18: The method of Aspect 17, further comprising: receiving a request for capability information associated with at least one of a null steering capability or DOA capability.

Aspect 19: The method of any of Aspects 17-18, further comprising: transmitting capability information indicating, for the UE, at least one of a null steering capability or DOA capability.

Aspect 20: The method of Aspect 19, wherein the capability information further indicates at least one of: a maximum number of directions available for null steering, a maximum width associated with the null steering, or an expected quality parameter associated with DOA estimation.

Aspect 21: The method of any of Aspects 17-20, further comprising: receiving a request for at least one communication parameter associated with the UE, wherein transmitting the at least one communication parameter comprises transmitting the at least one communication parameters in connection with receiving the request.

Aspect 22: The method of Aspect 21, further comprising: transmitting one or more updated communication parameters based on a condition being met.

Aspect 23: The method of Aspect 21, wherein the at least one communication parameter further comprises data indicating a UE location.

Aspect 24: The method of Aspect 23, further comprising: performing DOA estimation based on receiving the request for the at least one communication parameter.

Aspect 25: The method of Aspect 23, wherein the DOA estimate includes at least one of: a power estimate of an interference signal detected by the UE, a direction associated with the interference signal, or a beam width associated with the interference signal.

Aspect 26: The method of any of Aspects 17-25, wherein the interference indication indicates that the UE is to perform: null steering in an indicated direction, or altering the reception beam associated with the indicated direction.

Aspect 27: The method of Aspect 26, wherein the indicated direction is indicated via an index of directions.

Aspect 28: The method of Aspect 26, wherein the interference indication includes information identifying at least one beam index associated with the alteration of the reception beam.

Aspect 29: The method of any of Aspects 17-28, wherein the UE is scheduled to transmit a communication, and the interference indication indicates that the UE is to alter the transmission beam associated with an indicated direction.

Aspect 30: The method of Aspect 29, wherein the interference indication includes information identifying at least one beam index associated with the alteration of the transmission beam.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 32: An apparatus for wireless communication at a device, the apparatus comprising one or more memories and one or more processors coupled to the one or more memories, the one or more processors configured to cause the device to perform the method of one or more of Aspects 17-30.

Aspect 33: An apparatus for wireless communication, the apparatus comprising at least one means for performing the method of one or more of Aspects 1-16.

Aspect 34: A non-transitory computer-readable medium storing code for wireless communication, the code comprising instructions executable by one or more processors to perform the method of one or more of Aspects 17-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-16.

Aspect 36: A device for wireless communication, the device comprising a processing system that includes one or more processors and one or more memories coupled with the one or more processors, the processing system configured to cause the device to perform the method of one or more of Aspects 1-16.

Aspect 37: A device for wireless communication, the device comprising a processing system that includes one or more processors and one or more memories coupled with the one or more processors, the processing system configured to cause the device to perform the method of one or more of Aspects 17-30.

Aspect 38: An apparatus for wireless communication at a device, the apparatus comprising one or more memories and one or more processors coupled to the one or more memories, the one or more processors individually or collectively configured to cause the device to perform the method of one or more of Aspects 1-16.

Aspect 39: An apparatus for wireless communication at a device, the apparatus comprising one or more memories and one or more processors coupled to the one or more memories, the one or more processors individually or collectively configured to cause the device to perform the method of one or more of Aspects 17-30.

The foregoing disclosure provides illustration and description but is not intended to be exhaustive or to limit the aspects to the precise forms disclosed.

Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A network node for wireless communication, comprising:
one or more memories; and
one or more processors, coupled to the one or more memories, individually or collectively configured to:
identify, based on a schedule of upcoming transmissions in a cell served by the network node, an upcoming intra-cell interference scenario between a first user equipment (UE) and a second UE; and
transmit, to the first UE, an interference indication that indicates the first UE is to perform at least one of: null steering, altering a transmission beam of the first UE, or altering a reception beam of the first UE.

2. The network node of claim 1, wherein the one or more processors are further individually or collectively configured to:
transmit, to at least one UE in the cell, a request for capability information indicating, for the at least one UE, at least one of a null steering capability or direction of arrival (DOA) capability.

3. The network node of claim 1, wherein the one or more processors are further individually or collectively configured to:
receive, from at least one UE in the cell, capability information indicating, for the at least one UE, at least one of a null steering capability or direction of arrival (DOA) capability.

4. The network node of claim 3, wherein the capability information further indicates at least one of:
a maximum number of directions available for null steering,
a maximum width associated with the null steering, or
an expected quality parameter associated with DOA estimation.

5. The network node of claim 1, wherein the one or more processors are further individually or collectively configured to:
transmit, to at least one UE in the cell, a request for at least one communication parameter associated with the cell; and receive, from the at least one UE, the at least one communication parameter.

6. The network node of claim 5, wherein the at least one communication parameter comprises one or more of:
a direction of arrival (DOA) estimate, or
data indicating a UE location associated with the at least one UE.

7. The network node of claim 6, wherein the DOA estimate includes at least one of:
a power estimate of an interference signal detected by the at least one UE,
a direction associated with the interference signal, or
a beam width associated with the interference signal.

8. The network node of claim 1, wherein the one or more processors, to identify the upcoming intra-cell interference scenario, are individually or collectively configured to:
identify the upcoming intra-cell interference scenario based on one or more communication parameters, the one or more communication parameters including at least one of:
a network node direction of arrival (DOA) estimate,
one or more UE DOA estimates, or
UE location information.

9. The network node of claim 8, wherein the one or more processors, to identify the upcoming intra-cell interference scenario, are individually or collectively configured to:
identify the upcoming intra-cell interference scenario further based on an interference map that identifies the one or more communication parameters.

10. The network node of claim 8, wherein the one or more processors, to identify the upcoming intra-cell interference scenario, are individually or collectively configured to:
identify the upcoming intra-cell interference scenario in a portion of the cell associated with UEs that communicate via multi-user (MU) MIMO.

11. The network node of claim 1, wherein the one or more processors, to transmit the interference indication, are individually or collectively configured to:
transmit the interference indication based on the upcoming intra-cell interference scenario being associated with an amount of interference that satisfies an interference threshold.

12. The network node of claim 1, wherein the first UE is scheduled to receive a communication associated with the upcoming intra-cell interference scenario, and the interference indication indicates that the first UE is to perform:
null steering in an indicated direction, or
altering the reception beam associated with the indicated direction.

13. The network node of claim 12, wherein the indicated direction is indicated via an index of directions.

14. The network node of claim 12, wherein the interference indication includes information identifying at least one beam index associated with the altering of the reception beam.

15. The network node of claim 1, wherein the first UE is scheduled to transmit a communication associated with the upcoming intra-cell interference scenario, and the interference indication indicates that the first UE is to alter the transmission beam associated with an indicated direction.

16. The network node of claim 15, wherein the interference indication includes information identifying at least one beam index associated with the alteration of the transmission beam.

17. A user equipment (UE) for wireless communication, comprising:
one or more memories; and
one or more processors, coupled to the one or more memories, individually or collectively configured to:
transmit, to a network node, at least one communication parameter, the at least one communication parameter including at least a direction of arrival (DOA) estimate; and
receive, from the network node, an interference indication that indicates the UE is to perform at least one of: null steering, altering a transmission beam of the UE, or altering a reception beam of the UE.

18. The UE of claim 17, wherein the interference indication indicates that the UE is to perform:
null steering in an indicated direction, or
altering the reception beam associated with the indicated direction.

19. The UE of claim 17, wherein the UE is scheduled to transmit a communication, and the interference indication indicates that the UE is to alter the transmission beam associated with an indicated direction.

20. A method of wireless communication performed by a network node, comprising:
identifying, based on a schedule of upcoming transmissions in a cell served by the network node, an upcoming intra-cell interference scenario between a first user equipment (UE) and a second UE; and
transmitting, to the first UE, an interference indication that indicates the first UE is to perform at least one of: null steering, altering a transmission beam of the first UE, or altering a reception beam of the first UE.
